(19) United States
(12) Patent Application Publication
(10) Pub. No.: US 2012/0127841 A1
(43) Pub. Date: May 24, 2012

(54) PICKUP DEVICE AND OPTICAL DISC DRIVE ADOPTING THE SAME

(76) Inventors: Ui-yol Kim, Suwon-si (KR); Yong-jae Lee, Suwon-si (KR)

(21) Appl. No.: 13/287,396

(22) Filed: Nov. 2, 2011

(30) Foreign Application Priority Data
Nov. 19, 2010 (KR) 10-2010-0115739

(51) Int. Cl. G11B 7/135; G11B 7/1353; G11B 7/085; G11B 7/1374

(52) U.S. Cl. 369/44.26; 369/112.23; 369/112.03; 369/44.11; G9B/7.113; G9B/7.121; G9B/7.042; G9B/7.112

(57) ABSTRACT

Provided are a single beam optical pickup device and a disc drive including the optical pickup device. The optical pickup device includes a light controlling device that prevents or limits stray light generated from a medium from being incident on a light sensor. The light controlling device may further include an additional auxiliary light sensor so as to reuse effective light among diffracted light.

### CROSS-REFERENCE TO RELATED PATENT APPLICATION

This application claims the benefit of Korean Patent Application No. 10-2010-0115739, filed on Nov. 19, 2010, in the Korean Intellectual Property Office, the entire disclosure of which is incorporated herein by reference for all purposes.

### BACKGROUND

1. Field

The following description relates to an optical pickup device for optically recording information onto and detecting information from a medium such as a disc, and additionally, to an optical pickup device relating to a multi-layered medium.

2. Description of the Related Art

A three-beam type optical pickup device obtains one main beam and two sub-beams by using a grating element disposed between a beam splitter and a light source. A light receiving sensor converts a light beam which is reflected by a medium into an electric signal. The light receiving sensor includes a main beam region to which the main beam is directed and sub-beam regions to which the sub-beams are directed. The sub-beam regions are disposed on opposite sides of the main beam region.

In a three-beam type optical pickup device, a main beam (i.e., a 0th-order beam) is used to generate a main push-pull (MPP) signal of a track error signal (TES), a focus error signal (FES), and a radio frequency (RF) signal. Sub-beams (i.e., ±1st order beams) are used to generate a sub push-pull (SPP) signal of the TES.

Digital versatile disks (DVDs) and blu-ray disks (BDs) have multi recording layers. For example, DVDs and BDs have two or more recording layers. If information is being recorded to and reproduced from a multi-layered medium, an interference beam may occur in layers other than a currently accessed layer. The interference beam, as well as stray light, is dispersed very widely, operates as optical noise in an SPP signal, and interferes with a tracking control with respect to the medium.

The above phenomenon does not occur in single layered (SL) media. However, the above phenomenon is generated in dual-layered (DL) media and extended layer (XL) media. Therefore, research on the above phenomenon is necessary.

The above-identified problem caused by stray light also occurs in a one-beam type optical pickup device. In a conventional one-beam type optical pickup device, a region of a light receiving sensor on which beams from one beam are formed is divided into a direct current (DC) region to which a beam reflected by a groove (i.e., a data track) of the medium is directed, and alternating current (AC) regions to which beams reflected by lands on opposite sides of the groove are directed. However, stray light from adjacent layers may be incident on the DC region, and thus it is difficult to obtain signals necessary to perform a tracking control.

### SUMMARY

In one general aspect, there is provided a pickup device. The pickup device includes a light transmission system comprising an object lens configured to direct light to and receive light from a medium having multiple recording layers, a light source unit for transmitting to the light transmission system a beam that is used to record information onto or reproduce information from the multiple recording layers, a light receiving unit disposed on a proceeding path of the beam reflected by the medium and comprising a light sensor that senses light reflected from the medium, and a light controlling unit for controlling stray light generated by the medium.

The light controlling unit may control stray light so as to prevent the stray light from reaching the light sensor of the light receiving unit.

The light controlling unit may block or diffract at least one of a first polarized component of light reflected by the medium and a second polarized component of light reflected by the medium.

Light incident on the light controlling unit may include a first polarized component of light and a second polarized component of light, and the light controlling unit diffracts the first polarized component of light so that such diffracted light does reach the light sensor.

Light incident on the light controlling unit may include a first polarized component of light and a second polarized component of light, and the light controlling unit diffracts a first polarized component of light to generate 1st order beams, and the light receiving unit further comprises auxiliary sensors configured to receive the 1st order beams of effective light generated by the medium.

The pickup device may include a quarter wave plate that is disposed between the light controlling unit and the object lens.

The pickup device may include a quarter wave plate that is disposed between the light controlling unit and the object lens.

The light receiving unit of the pickup device may further include auxiliary sensors that are configured to receive 1st order beams of effective light in the light reflected that are disposed on opposite sides of the light sensor, the light controlling unit may control stray light in light reflected by the medium, so that the stray light is not be incident on the light sensor, and the light controlling unit may control the stray light by at least one of partially blocking the stray light and diffracting the stray light.

The pickup device may include an additional optical system that shares a part of an optical path of the light transmission system, and comprises an additional object lens and an additional light source that are configured to transmit light to another type of medium.

The pickup device may include an additional optical system that shares a part of an optical path of the light transmission system, and comprises an additional object lens and an additional light source that are configured to transmit light to another type of medium.

The pickup device may include an additional optical system that reads or writes information to a storage medium having a format of at least one of a compact disk (CD)/digital versatile disk (DVD), and the additional optical system has a three-beam optical structure including a diffraction unit that divides a light beam emitted from the additional light source into three beams.

The light controlling unit may be disposed on a segment of an optical path of the pickup device corresponding to a light receiving path.

An electronic device may include therein the pickup device. The electronic device may be one of a portable game console, a portable/personal multimedia player (PMP), a portable lap-top PC, a desktop PC, a game console, a high definition television (HDTV), an optical disc player/recorder, and a set top box.

In another aspect, there is provided a disc drive. The disc drive includes a pickup device, an information processing unit for processing signals output from the pickup device, a servo unit for generating signals for controlling the pickup device, and a central processing unit for controlling the information processing unit and the servo unit. The pickup device includes a light transmission system comprising an object lens configured to direct light to and receive light reflected from a medium having multiple recording layers, a light source unit configured to transmit to the light transmission system a single beam that is used to record information onto or reproduce information from the multiple recording layers, a light receiving unit disposed on a proceeding path of the beam reflected by the medium and comprising a light sensor that senses light reflected from the medium, and a light controlling unit for controlling stray light generated by the medium.

The light controlling unit may control unit controls stray light so as to prevent the stray light from reaching the light sensor of the light receiving unit.

The light controlling unit may block or diffract at least one of a first polarized component of light reflected by the medium and a second polarized component of light reflected by the medium.

Light incident on the light controlling unit may include a first polarized component of light and a second polarized component of light, and the light controlling unit diffracts the first polarized component of light so that the diffracted light does not reach the light receiving cell.

Light incident on the light controlling unit may include a first polarized component of light and a second polarized component of light, and the light controlling unit diffracts a first polarized component of light to generate 1st order beam. The light receiving unit may also include auxiliary sensors that are configured to receive the 1st order beams of effective light generated by the medium during the diffraction.

The light controlling unit may be disposed on a segment of an optical path of the pickup device corresponding to a light receiving path.

An electronic device may include therein the disc drive. The electronic device may be one of a portable game console, a portable/personal multimedia player (PMP), a portable lap-top PC, a desktop PC, a game console, a high definition television (HDTV), an optical disc player/recorder, and a set top box.

In another aspect, there is provided a disc drive. The disc drive includes a pickup device, an information processing unit for processing signals output from the pickup device, a servo unit for generating signals for controlling the pickup device, and a central processing unit for controlling the information processing unit and the servo unit. The pickup device includes a light transmission system comprising an object lens configured to direct light to and receive light reflected from a medium having multiple recording layers, a light source unit configured to transmit to the light transmission system a single beam that is used to record information onto or reproduce information from the multiple recording layers, a light receiving unit disposed on a proceeding path of the beam reflected by the medium and comprising a sensor that senses light reflected from the medium, a light controlling unit for controlling stray light generated by the medium, and an additional optical system sharing a part of an optical path of the light transmission system, and including an additional object lens and an additional light source that are configured to transmit light to another type of medium.

The additional optical system may read or write information to a storage medium having a format of at least one of a compact disk (CD)/digital versatile disk (DVD), and the additional optical system has a three-beam optical structure including a diffraction unit that divides a light beam emitted from the additional light source into three beams.

An electronic device may include therein the disc drive. The electronic device may be one of a portable game console, a portable/personal multimedia player (PMP), a portable lap-top PC, a desktop PC, a game console, a high definition television (HDTV), an optical disc player/recorder, and a set top box.

Other features and aspects may be apparent from the following detailed description, the drawings, and the claims.

### BRIEF DESCRIPTION OF THE DRAWINGS

FIG. 1 is a diagram illustrating an example of an optical pickup device.

FIG. 2 is a diagram illustrating an example of a light receiving device included in an optical pickup device.

FIG. 3 is a diagram illustrating an example of a light controlling unit in an optical pickup device.

FIG. 4 is a diagram illustrating an example of a distribution of incident light on a light receiving device of FIG. 2;

FIG. 5 is a diagram illustrating an example of a distribution of stray light incident on a light receiving device in a conventional optical pickup device.

FIG. 6 is a diagram illustrating an example of generation of stray light from layers adjacent to a target layer in a multi-layered medium.

FIG. 7 is a diagram illustrating an example of simulation results of a conventional single beam type optical pickup device having no polarization controlling device.

FIG. 8 is a diagram illustrating an example of simulation results of the optical pickup device of FIG. 1.

FIG. 9 is a graph illustrating an example of shaking of tracking error signals (TESs) according to the simulation results illustrated in FIGS. 7 and 8;

FIG. 10 is a diagram illustrating an example of a distribution of incident light on a light receiving device in an optical pickup device.

FIG. 11 is a diagram illustrating an example of diffraction of an incident beam by a polarization controlling unit.

FIG. 12 is a diagram illustrating an example of simulation results of a distribution of an incident beam on the light receiving device in the optical pickup device of FIG. 10.

FIG. 13 is a diagram illustrating an example of an optical pickup device.

FIG. 14 is a diagram illustrating an example of a configuration of incident light that is formed from light that is diffracted by a light controlling device on the light receiving sensor.

FIG. 15 is a diagram illustrating an example of an optical disc drive.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

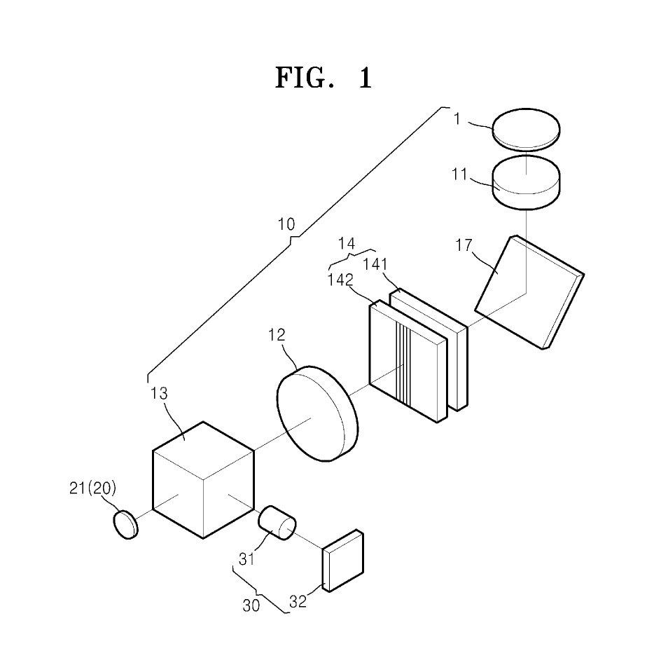

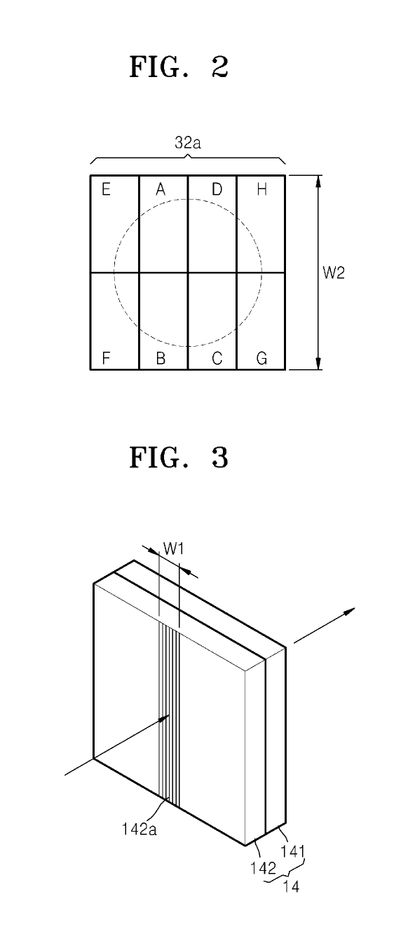

FIG. 1 is a diagram illustrating an example of a one-beam type optical pickup device that uses a multi-layered medium. For example, the one-beam type optical pickup uses a blu-ray disc (BD). FIG. 2 is a diagram illustrating an example of a light receiving device included in an optical pickup device.

The optical pickup device includes a light transmission system 10 directly corresponding to a medium 1, a light source system 20 that includes a light source 21 which provides a single light beam for reproducing information from or recording information onto the medium 1, and a light receiving system 30 that includes a light receiving device 32 that receives light reflected by the medium 1 to generate electric signals such as data signals and tracking error signals (TESs) required in processing.

The light receiving system 30 includes a main light receiving cell 32a that detects a signal beam reflected by the medium 1 and by a beam splitter 13 to generate an electric signal. In addition, the light receiving system 30 includes a sensing lens 31 that converges a signal beam reflected by the medium 1 and by the beam splitter 13 to an appropriate size. The light receiving cell 32a may be disposed on the light receiving device 32. The main light receiving cell 32a includes a plurality of sectors. For example, the light receiving cell 32a may include 8-divided sectors A through H.

The light transmission system 10 includes an object lens 11, a path-changing mirror 17, a collimating lens 12, and the beam splitter 13. For example, the objective lens 11 is configured so as to direct light onto and receive light that is reflected from the medium 1. The beam splitter 13 transmits light emitted from the light source system 20 toward the object lens 11, and reflects light incident on the beam splitter 13 that was reflected by the medium 1 toward the light receiving system 30. The light transmission system may further include a light controlling unit 14. A light controlling unit 14 includes a quarter wave plate (QWP) 141, and a partial polarization controlling device 142. The QWP 141 and the partial polarization controlling device 142 may be adjacent to each other as shown in FIG. 1, or may be integrally formed with each other as shown in FIG. 3. The beam splitter 13 and the collimating lens 12 may be separated from each other. For example, the partial polarization controlling device 142 may be located between the beam splitter 13 and the collimating lens 12.

The partial polarization controlling device 142 blocks a polarized component light that is polarized in a first direction. The polarized component of light polarized the first direction (hereinafter, referred to as a first polarization) is a p-polarized component or an s-polarized component. That is, the partial polarization controlling device 142 blocks a component of an incident light beam that is polarized in a certain direction, for example, the p-polarized component (hereinafter, referred to as a p-polarization) or the s-polarized component (hereinafter, referred to as an s-polarization). For purposes of clarity and convenience in the disclosure hereafter, further reference to the first polarization corresponds to the p-polarization.

Referring to FIG. 3, the partial polarization controlling device 142, which blocks or diffracts the first polarization, includes a strip-type polarization controlling unit 142a having a predetermined width and extending in a direction along, for example, a dimension of the partial polarization controlling device 142.. The strip-type polarization controlling unit 142a is a light blocking or hologram diffraction region that blocks or diffracts the first polarization, for example, the p-polarization, and transmits a second polarization, for example, the s-polarization. The blocking or diffracting of the first polarization is performed with respect to both progressing light from the light source 21 a and regressing or reflected light from the medium 1. For example, a width W1 of the strip-type polarization controlling unit 142a, that is, a controlling region, corresponds to a width W2 (in a vertical direction in the drawings) of the main light receiving cell 32a of the light receiving device 32. The polarization controlling unit 142a blocks or diffracts the first polarization in stray light that is incident on a region where the main light receiving cell 32a is formed. Therefore, the main light receiving cell 32a detects a beam spot without detecting stray light.

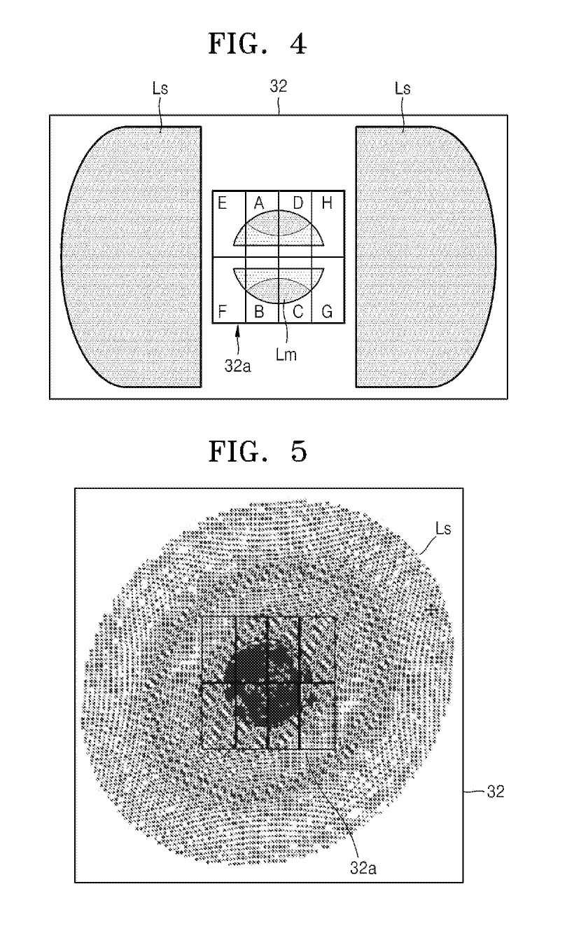

Referring to FIG. 4, a main beam Lm incident on the main light receiving cell 32a forms a beam spot that is divided into two semicircular shapes. As described above, it is because a center portion of an effective beam reflected by the medium 1 is blocked or diffracted. The polarization controlling unit 142a blocks or diffracts the p-polarization in progressing light and reflected light. The s-polarization, which transmits through the polarization controlling device 142, and the p-polarization, which has its center portion blocked by the polarization controlling unit 142a, are circular-polarized when passed through the QWP 141.

A polarization direction of a light (beam) reflected by the medium 1 is changed to be opposite to that of light to be incident on the medium 1. For example, a light incident on the medium 1 that has a right-hand polarization is changed into a left-handed polarization. In addition, the left-handed polarization is changed into the p-polarization when passed through the QWP 141. Accordingly, a part of the p-polarization is blocked or diffracted by the polarization controlling unit 142a, and thus may not reach the main light receiving cell 32a.

As shown in FIG. 4, through the above processes, a beam spot without the p-polarization and without a center portion is formed on the main light receiving cell 32a, and stray light Ls not controlled by the polarization controlling unit 142a is incident only on an outside region of the main light receiving cell 32a.

A conventional one-beam type optical pick up device includes a light controlling unit 14 that only includes the QWP 141. In other words, conventional optical pick up devices do not include a polarization controlling unit. Therefore, stray light is incident on the main cell 32a of a conventional optical pickup device. Stray light functions as optical noise in a sub push-pull (SPP) signal, and interferes with a tracking control with respect to the medium.

FIG. 5 illustrates a distribution (region) of stray light Ls incident on the light receiving device 32 in a conventional structure (i.e., a structure not having the partial polarization controlling device 142a). As shown in FIG. 5, a main beam and sub-beams on opposite sides of the main beam form a beam spot in each of the cells of the light receiving device 32, and the stray light Ls is incident on the entire surface of the light receiving device 32 including the cells.

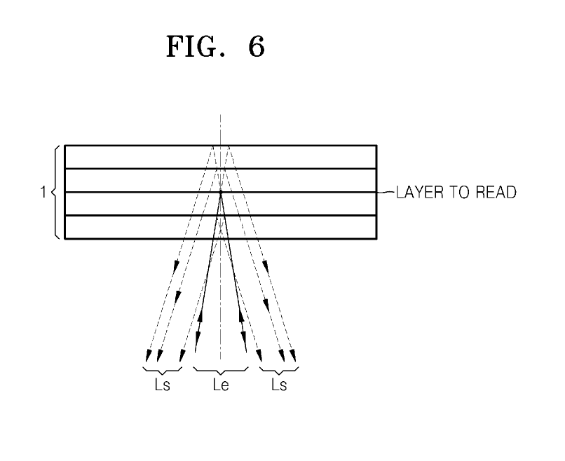

FIG. 6 is a diagram showing a mechanism of generating stray light in a multi-layered medium. When a beam spot is formed on a target layer that is a layer on which reading or recording is to be performed (layer to read), a part of the beam incident on the target layer is reflected by a layer above the target layer or transmitted to a layer below the target layer and reflected by the lower layer, and thus stray light Ls is generated. The stray light Ls is irradiated much more widely than effective light Le reflected by the target layer. If stray light Ls is incident on the main light receiving device 32a as shown in FIG. 5, the stray light Ls is detected as optical noise by the main light receiving cell 32a. However, the polarization controlling device 142 effectively prevents or limits the amount of stray light Ls that reaches the main light receiving cell 32a. Thus, the stray light Ls is not detected as noise by the main light receiving cell 32a.

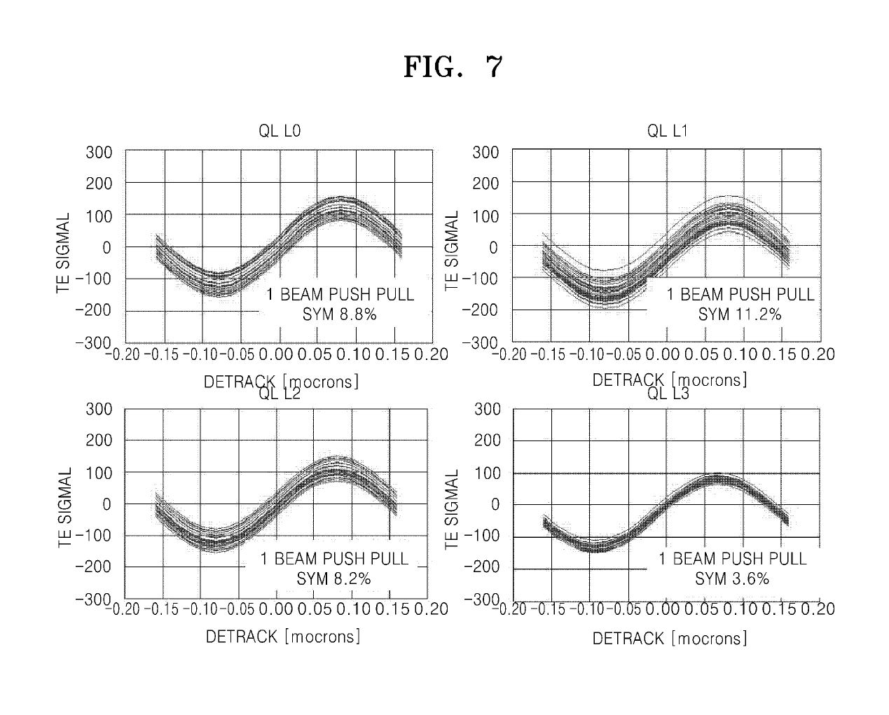

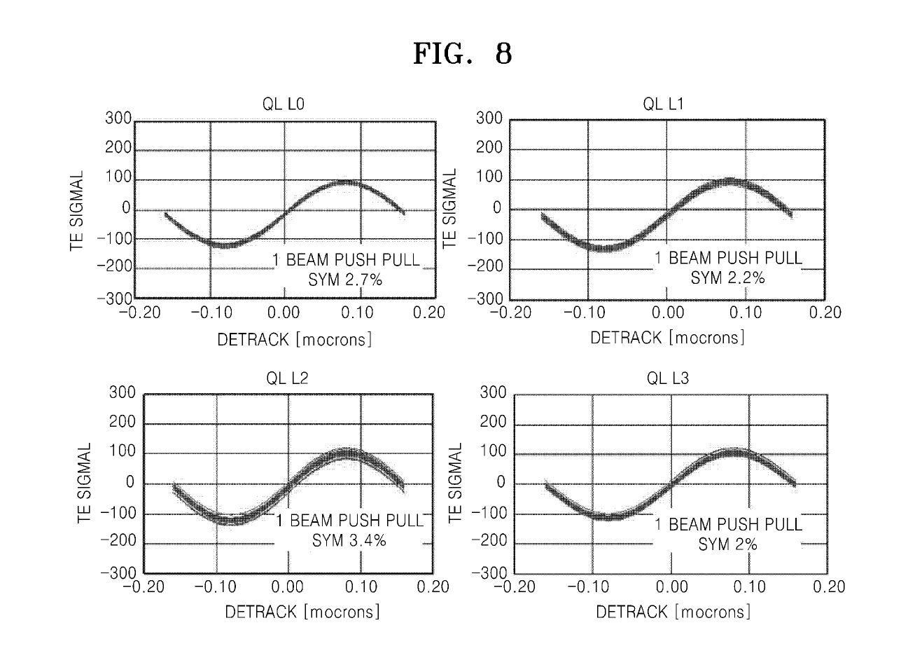

FIGS. 7 and 8 show differential push-pull (DPP) simulation (SYM) results of TES interference with respect to a quadruple layer medium. In more detail, FIG. 7 shows simulation results of a conventional one-beam type optical pickup device having no polarization controlling device. In contrast, FIG. 8 shows an example of simulation results using an optical pickup device having a polarization controlling device.

As shown in FIGS. 7 and 8, variation of waveforms shown in FIG. 7 is wide compared to variation of waveforms shown in FIG. 8.

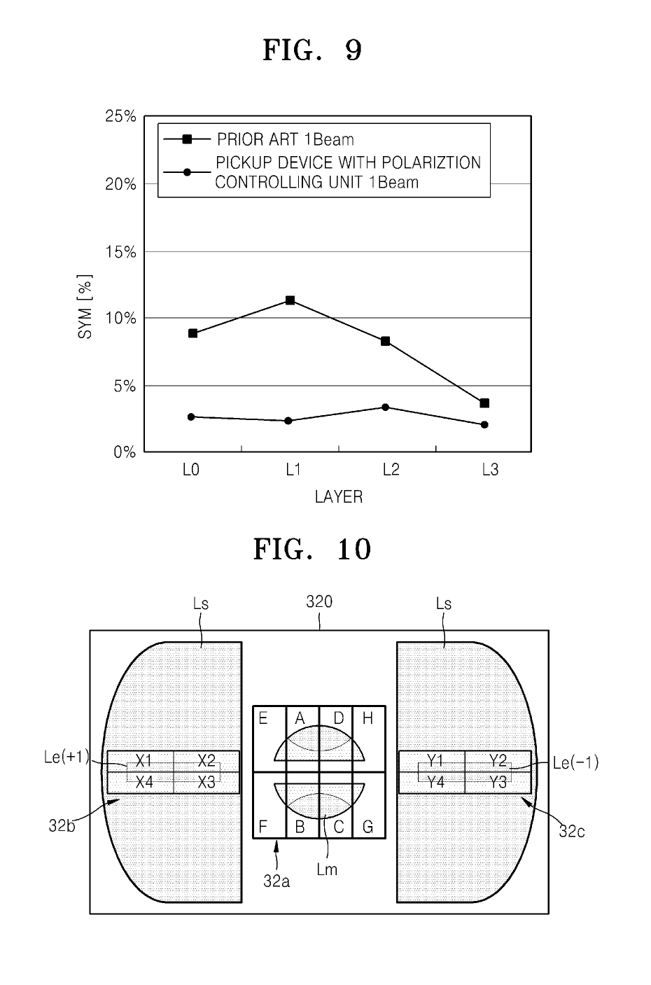

The following Table 1 illustrates comparisons of TES shaking as the results of the simulations shown in FIGS. 7 and 8. FIG. 9 is a graph illustrating Table 1.

TABLE 1

| | L0 | L1 | L2 | L3 |
|---|---|---|---|---|
| Conventional | 8.8% | 11.2% | 8.2% | 3.6% |
| art | | | | |
| Present | 2.7% | 2.2% | 3.4% | 2.0% |
| embodiment | | | | |

As illustrated in Table 1, a high quality TES having less signal shaking may be obtained. The above result is obtained by preventing stray light, detected as noise by the main light receiving cell 32a, from being incident on the light receiving device 32. However, the polarization controlling unit 142, which blocks or diffracts the stray light, also cuts a part of a main beam spot Lm formed by a main beam incident on the main light receiving cell 32a. As shown in FIG. 4, a center portion of an effective beam spot, that is, the main beam spot, formed on the main light receiving cell 32a is cut. Therefore, an intensity of effective light incident on the main light receiving cell 32a is reduced in optical pickup devices having a polarization controlling unit relative to the intensity of effective light in an optical pickup device not having polarization controlling unit. Accordingly, RF signals obtained from the light receiving device 32 may be reduced less than those of the conventional art. The above reduction may be compensated for to prevent a problem from generating in reproduction of signals. However, auxiliary sensors 32b and 32c for RF signals that will be described later may be additionally formed without performing the above additional compensation so that RF signals having the same magnitude or the same jitter quality as those of the conventional art may be obtained.

FIG. 10 illustrates an example of a light receiving device 320.

The light receiving device 320 has a structure in which the auxiliary sensors 32b and 32c are disposed on stray light LS incident region. Effective light beams Le (+1) and Le (−1) are formed separated from each other by diffracting a reflected beam that includes stray light Ls and effective light Le. The auxiliary sensors 32b and 32c, each include a plurality of light receiving sensors. For example, the auxiliary sensor 32b includes the plurality of light sensors X1, X2, X3, and X4; and the auxiliary sensor 32c includes the plurality of light sensors Y1, Y2, Y3, and Y4. The auxiliary sensors 32b and 32c are disposed on opposite sides of the main light receiving cell 32a. Therefore, the effective light beams Le (+1) and Le (−1), which are diffracted by the polarization controlling device 142, are incident on the auxiliary sensors 32b and 32c together with the stray light Ls. The diffracted effective light beams Le (+1) and Le (−1) are detected by the auxiliary sensors 32b and 32c and are used as RF signals.

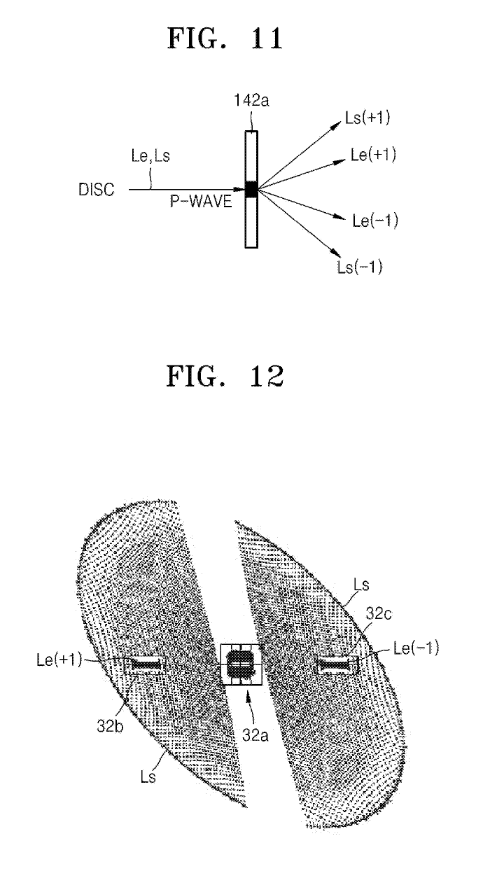

To do this, as shown in FIG. 11, the polarization controlling unit 142a of the polarization controlling device 142 diffracts a center portion of an incident light beam to generate ±1st order beams so that some of an effective light beam diffracted by the polarization controlling device 142 may be incident on the auxiliary sensors 32b and 32b. For example, the polarization controlling unit 142a is designed such that ±1 st order beams Le (+1) and Le (−1) of effective light Le may be incident on the auxiliary sensors 32b and 32c. Stray light Ls has a wider irradiation angle than the effective light Le, which is reflected by a target layer of a medium, and is diffracted by the polarization controlling unit 142a at a greater angle than the effective light Le, and thus the stray light Ls is not incident on the auxiliary sensors 32b and 32c. The effective light beams Le (+1) and Le (−1), which are diffracted at a smaller angle than the stray light Ls, are incident on the auxiliary sensors 32b and 32c.

Stray light Ls that is not controlled by the polarization controlling unit 142a may also be incident on the auxiliary sensors 32b and 32c; however, such stray light Ls incident on the auxiliary sensors 32b and 32c has lower intensity than effective light Le reflected by a target layer of a medium. In addition, signals obtained from the auxiliary sensors 32b and 32c are used only as RF signals and not used in tracking error detection and thus do not affect an MPP signal.

As previously discussed, each of the auxiliary sensors 32b and 32c may include a plurality of light receiving sectors X1, X2, X3, and X4, and Y1, Y2, Y3, and Y4 as shown in FIG. 10. When RF signals are detected, signals of all sectors in each plurality of auxiliary sensors 32b and 32c are added together (X1+X2+X3+X4) and (Y1+Y2+Y3+Y4), and the signals may be used to check centering of a main beam. As another example of checking the centering of the main beam, when the signals in the sectors of each auxiliary sensor 32b or 32c are the same as each other within a predetermined range (for example, X1 X2 X3 X4, and Y1 Y2 Y3 Y4), it is determined that the main beam is centered on the main light receiving cell 32a.

FIG. 12 is a diagram illustrating an example of simulation results of a distribution of incident light on an arrangement of the main light receiving cell 32a and the auxiliary sensors 32b and 32c of the light receiving device 320. In FIG. 11, a darkest portion in each of the main light receiving cell 32a and the auxiliary sensors 32b and 32c denotes a beam spot.

When using electric signals obtained from the main light receiving cell 32a and the auxiliary sensors 32b and 32c, a focus error signal (FES) is a single differential push-pull method, as represented by the following equation. That is, the FES is a difference between a sum of signals of the sectors A and E and C and G, and a sum of signals of the sectors B and F and D and H in the main light receiving cell 32a.

FES=(A+E+C+G)−(B+F+D+H)

An RF signal is the sum of the signals in all of the sectors in the light receiving sensor 320 as represented by the following equation.

RF=A+B+C+D+X1+X2+X3+X4+Y1+Y2+Y3+Y4

In addition, a track error signal (TES) is obtained by the following equation according to a one-beam push-pull method.

TES={(A+D)−(B+C)−k(E+H)−k(F+G)}

Here, k is a constant corresponding to a lens shift with respect to a track contacting direction.

Electrical noise caused by stray light or interference light may be reduced by effectively controlling the light when recording information onto or reproducing information from a medium. Thus, a TES of excellent quality may be generated so as to effectively control tracking.

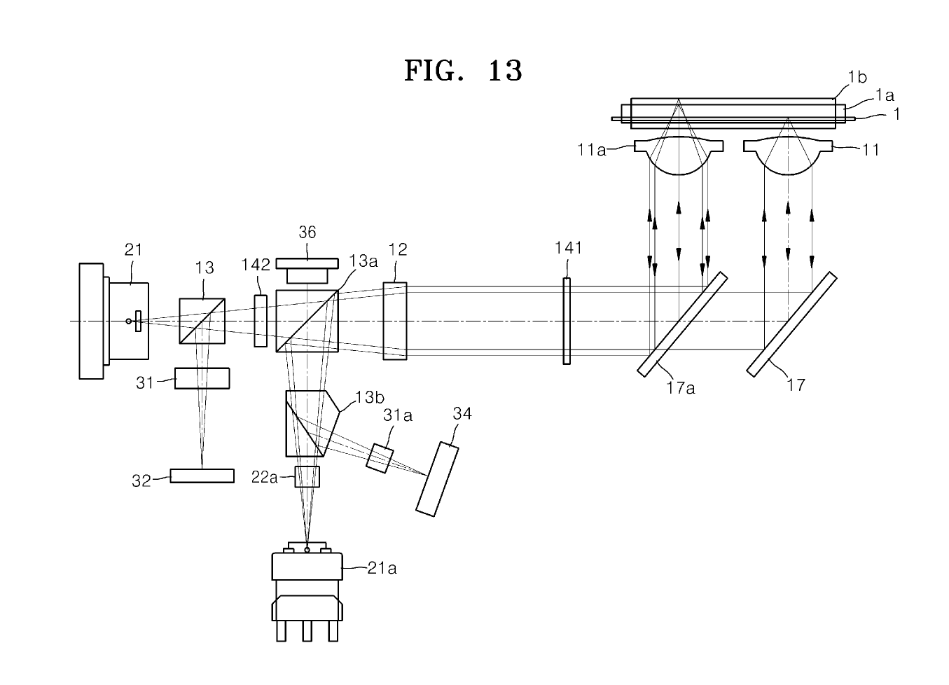

The above described structure is related to an optical pickup device for a recording medium such as a BD. However, the above structure may be applied to an optical pickup device that is compatible with various other types of optical recording medium or an optical device that may be compatible with multiple media. For example, the optical pickup device describe above may be configured to be compatible with compact disks (CDs)/DVDs/BDs. For example, FIG. 13 illustrates an example of an optical pickup device that is configured to be compatible with a DVD 1a and a CD 1b in addition to a BD1.

When comparing the compatible optical pickup device of FIG. 13 with the optical pickup device shown in FIG. 1, optical components for recording information onto or reproducing information from other recording media la and lb (e.g., the DVD 1a and the CD 1b) are further included in the compatible optical pickup device of FIG. 13. Here, components that are the same as or similar to those of FIG. 1 are denoted with the same reference numerals, and descriptions thereof are not provided.

Referring to FIG. 13, the compatible optical pickup device includes the object lens 11 for a BD that focuses third light emitted from the light source 21 having a wavelength of 405 nm, and the light receiving device 32 for detecting the third light reflected by the BD 1. The light receiving sensor 32 may include the main light receiving cells 32a, and the auxiliary sensors 32b and 32c on opposite sides of the main light receiving cell 32a as optional elements, as described above.

The beam splitter 13, which is an optical path converter that makes the third light proceed toward the BD 1 and reflects the third light reflected by the BD 1 toward the light receiving sensor 32, is disposed on an optical path between the light source 21 for a BD and the object lens 11. The sensing lens 31 for detecting a FES by using a push-pull method is disposed on an optical path between the beam splitter 13 and the light receiving sensor 32. On the other hand, the polarization controlling device 142, a second beam splitter 13a, the collimating lens 12, the QWP 141, and a dichroic mirror 17a are disposed on an optical path between the beam splitter 13 and a reflective mirror 17 in a light proceeding direction. The dichroic mirror 17a transmits the third light toward the BD1, and reflects first and second lights for the CD lb and the DVD la toward an object lens 11 a for a CD/DVD.

On the other hand, a three-beam grating element 22a and a third beam splitter 13b are disposed on an optical path between a light source 21a for a CD/DVD and the second beam splitter 13a. A sensing lens 31a a three-beam light receiving device 34a for a CD/DVD are disposed on an optical path of light reflected from the third beam splitter 13b. In addition, a monitoring light receiving sensor 36 for monitoring light intensities of the light sources 21 and 21a is disposed on a side of the third beam splitter 13b.

The above described structure is a combined structure of a one-beam type BD optical system and a three-beam type CD/DVD optical system, in which the stray light controlling structure described above is additionally formed on the one-beam type BD optical system.

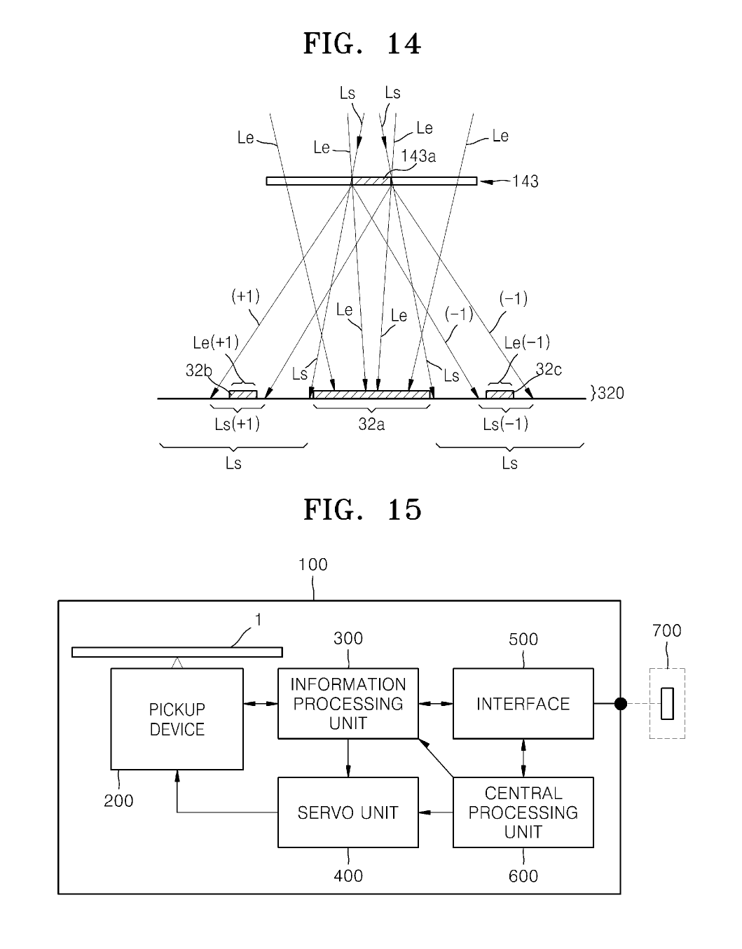

The partial polarization controlling device 142 is disposed in a light transmission system from the light source 21 to the BD 1. However, according to another aspect, a hologram device 143 disposed on a light receiving path may be disposed instead of the partial polarization controlling device 142 disposed on a proceeding path of light. In other words, the partial polarization controlling device 142 disposed in the light transmission path may be replaced with a hologram device 143 that is disposed in the light receiving path. FIG. 14 illustrates the hologram device 143 disposed in the light receiving path.

Referring to FIG. 14, the hologram device 143 having a diffraction pattern 143a is disposed on a proceeding path of effective light Le and stray light Ls incident on the light receiving device 32 so that the stray light Ls may not be incident on the main light receiving cell 32a of the light receiving sensor 320.

The diffraction pattern 143a blocks or diffracts stray light Ls so that the stray light may not be incident on the main light receiving cell 32a. For example, when the stray light Ls is partially diffracted, effective light Le is partially diffracted too, and the diffraction pattern 143a may be designed such that diffracted effective light beams Le (+1) and Le(−1) are incident on the auxiliary sensors 32b and 32c disposed on opposite sides of the main light receiving cell 32a. When the effective light Le is partially not incident on the main light receiving cell 32a, the magnitude of an RF signal that is obtained by the main light receiving cell 32a is reduced. The auxiliary sensors 32b and 32c are formed to receive the diffracted effective beams Le (+1) and Le(−1) as an RF signal.

An optical pickup device having the above-described stray light controlling structure, may prevent or inhibit the degradation of control signals caused by stray light.

FIG. 15 is a diagram illustrating an example of the schematics of an optical disc drive 100.

The optical disc drive 100 reads information from or records information onto discs 1 (1a and 1b), and includes an optical pickup device 200 such as the optical pickup device described above. For example, the optical pickup device 200 includes an optical system described above, and a mechanical system that mechanically supports the optical system and performs a focusing operation and a tracking operation. The optical system includes an encoder/decoder, and the optical system is connected to an information processing unit 300 that is connected to an interface 500 for connecting to an external host. In addition, the mechanical system is connected to a servo unit 400. The information processing unit 300, the servo unit 400, and the interface 500 are controlled by a central processing unit 600. The interface 500 may correspond to various standards, for example, a universal serial bus (USB) port, and thus the disk drive 100 is connected to a host, for example, a computer 700, via the USB protocol to exchange information.

For example, stray light that is generated in a multi-layered medium such as a DVD or a BD may be controlled appropriately so that only effective light and not the stray light reaches a light receiving device. The amount of stray light that reaches a light receiving device may be reduced or minimized by using, for example, a polarization controlling unit. Therefore, generation of noise caused by the stray light may be prevented or reduced, and a high quality sub push-pull signal may be obtained. Thus, tracking control error caused in the multi-layered medium by the stray light may be effectively prevented.

An aspect provides an optical pickup device capable of effectively controlling interference light occurring in a multi-layered medium having two or more recording layers, and an optical disc drive adopting the optical pickup device.

An aspect also provides an optical pickup device capable of effectively restraining track controlling errors in a multi-layered medium, and an optical disc drive adopting the optical pickup device.

Disk drives as described in the above examples may be included in an electronic device. As a non-exhaustive illustration only, an electronic device described herein may refer to devices such as a digital camera, a portable game console, a portable/personal multimedia player (PMP), a portable lap-top PC, and devices such as a desktop PC, a high definition television (HDTV), an optical disc player, a set top box, and the like that may be capable of wireless communication or network communication.

The units described herein may be implemented using hardware components and software components. For example, microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A pickup device comprising:
a light transmission system comprising an object lens configured to direct light to and receive light from a medium having multiple recording layers;
a light source unit configured to transmit to the light transmission system a beam that is used to record information onto or reproduce information from the multiple recording layers;
a light receiving unit disposed on a proceeding path of the beam reflected by the medium and comprising a light sensor that senses light reflected from the medium; and
a light controlling unit configured to control stray light generated by the medium.

2. The pickup device of claim 1, wherein the light controlling unit controls stray light so as to prevent the stray light from reaching the light sensor of the light receiving unit.

3. The pickup device of claim 2, wherein the light controlling unit blocks or diffracts at least one of a first polarized component of light reflected by the medium and a second polarized component of light reflected by the medium.

4. The pickup device of claim 2, wherein light incident on the light controlling unit includes a first polarized component of light and a second polarized component of light, and the light controlling unit diffracts the first polarized component of light so that such diffracted light does reach the light sensor.

5. The pickup device of claim 2, wherein light incident on the light controlling unit includes a first polarized component of light and a second polarized component of light, and the light controlling unit diffracts a first polarized component of light to generate ±1st order beams, and the light receiving unit further comprises auxiliary sensors configured to receive the ±1st order beams of effective light generated by the medium.

6. The pickup device of claim 1, wherein a quarter wave plate is disposed between the light controlling unit and the object lens.

7. The pickup device of claim 2, wherein a quarter wave plate is disposed between the light controlling unit and the object lens.

8. The pickup device of claim 2, wherein the light receiving unit further comprises auxiliary sensors that are configured to receive ±1st order beams of effective light in the light reflected that are disposed on opposite sides of the light sensor;
wherein the light controlling unit controls stray light in light reflected by the medium, so that the stray light is not be incident on the light sensor;
wherein the light controlling unit controls the stray light by at least one of partially blocking the stray light and diffracting the stray light.

9. The pickup device of claim 1, further comprising an additional optical system that shares a part of an optical path of the light transmission system, and comprises an additional object lens and an additional light source that are configured to transmit light to another type of medium.

10. The pickup device of claim 2, further comprising an additional optical system that shares a part of an optical path of the light transmission system, and comprises an additional object lens and an additional light source that are configured to transmit light to another type of medium.

11. The pickup device of claim 9, wherein the additional optical system reads or writes information to a storage medium having a format of at least one of a compact disk (CD)/digital versatile disk (DVD), and the additional optical system has a three-beam optical structure including a diffraction unit that divides a light beam emitted from the additional light source into three beams.

12. The pickup device of claim 8, wherein the light controlling unit is disposed on a segment of an optical path of the pickup device corresponding to a light receiving path.

13. A disc drive comprising:
a pickup device;
an information processing unit configured to process signals output from the pickup device;
a servo unit for generating signals for controlling the pickup device; and
a central processing unit for controlling the information processing unit and the servo unit,
wherein the pickup device comprises:
a light transmission system comprising an object lens configured to direct light to and receive light reflected from a medium having multiple recording layers;
a light source unit configured to transmit to the light transmission system a single beam that is used to record information onto or reproduce information from the multiple recording layers;
a light receiving unit disposed on a proceeding path of the beam reflected by the medium and comprising a light sensor that senses light reflected from the medium; and
a light controlling unit configured to control stray light generated by the medium.

14. The disc drive of claim 13, wherein the light controlling unit controls stray light so as to prevent the stray light from reaching the light sensor of the light receiving unit.

15. The disc drive of claim 14, wherein the light controlling unit blocks or diffracts at least one of a first polarized component of light reflected by the medium and a second polarized component of light reflected by the medium.

16. The disc drive of claim 13, wherein light incident on the light controlling unit includes a first polarized component of light and a second polarized component of light, and the light controlling unit diffracts the first polarized component of light so that the diffracted light does not reach the light receiving cell.

17. The disc drive of claim 14, wherein light incident on the light controlling unit includes a first polarized component of light and a second polarized component of light, and the light controlling unit diffracts a first polarized component of light to generate ±1st order beams,
wherein the light receiving unit further comprises auxiliary sensors that are configured to receive the ±1st order beams of effective light generated by the medium during the diffraction.

18. The disc drive of claim 13, wherein the light controlling unit is disposed on a segment of an optical path of the pickup device corresponding to a light receiving path.

19. A disc drive comprising:
a pickup device;
an information processing unit configured to process signals output from the pickup device;
a servo unit configured to generate signals that control the pickup device; and
a central processing unit configured to control the information processing unit and the servo unit,
wherein the pickup device comprises:
a light transmission system comprising an object lens configured to direct light to and receive light reflected from a medium having multiple recording layers;
a light source unit configured to transmit to the light transmission system a single beam that is used to record information onto or reproduce information from the multiple recording layers;
a light receiving unit disposed on a proceeding path of the beam reflected by the medium and comprising a sensor that senses light reflected from the medium;
a light controlling unit configured to control stray light generated by the medium; and
an additional optical system sharing a part of an optical path of the light transmission system, and comprising an additional object lens and an additional light source that are configured to transmit light to another type of medium.

20. The disc drive of claim 19, wherein the additional optical system reads or writes information to a storage medium having a format of at least one of a compact disk (CD)/digital versatile disk (DVD), and the additional optical system has a three-beam optical structure including a diffraction unit that divides a light beam emitted from the additional light source into three beams.

21. An electronic device, the electronic device comprising the pickup device of claim 1, wherein the electronic device is one of a portable game console, a portable/personal multimedia player (PMP), a portable lap-top PC, a desktop PC, a game console, a high definition television (HDTV), an optical disc player/recorder, and a set top box.

22. An electronic device, the electronic device comprising the disc drive of claim 13, wherein the electronic device is one of a portable game console, a portable/personal multimedia player (PMP), a portable lap-top PC, a desktop PC, a game console, a high definition television (HDTV), an optical disc player/recorder, and a set top box.

23. An electronic device, the electronic device comprising the disc drive of claim 19, wherein the electronic device is one of a portable game console, a portable/personal multimedia player (PMP), a portable lap-top PC, a desktop PC, a game console, a high definition television (HDTV), an optical disc player/recorder, and a set top box.
